(19) United States
(12) Patent Application Publication
(10) Pub. No.: US 2022/0194070 A1
(43) Pub. Date: Jun. 23, 2022

(54) SHEET PROCESSING SYSTEM AND METHOD

(71) Applicant: Aharon BAR, Rishon Lezion (IL)

(72) Inventor: Aharon BAR, Rishon Lezion (IL)

(21) Appl. No.: 17/125,008

(22) Filed: Dec. 17, 2020

(51) Int. Cl. B32B 37/12; B41J 3/407; B32B 37/10; B32B 39/00

(52) U.S. Cl. CPC B32B 37/12; B41J 3/4075; B32B 2519/00; B32B 39/00; B32B 37/10

(57) ABSTRACT

A sheet processing system including: a sheet feeding station, configured to feed and place single and separate printed sheets, one at a time, on at least one continuous sheet, one printed sheet adjacent to the other with a front edge of one printed sheet of the separate printed sheets overlapping on top of or below a rear edge of its previously fed printed sheet; and a pressing roller configured to move the at least one continuous sheet, and to adhere the at least one continuous sheet on the printed sheets, thereby turning each one of the fed single and separate printed sheets into a continuous printed sheet (roll), thereby allowing utilizing a separated sheet printer for producing the printed roll.

### FIELD OF THE INVENTION

The present invention relates to sheet printing, more particularly, to a system and a method for producing printed items.

### BACKGROUND OF THE INVENTION

Production of printed items such as stickers and roll labels is generally a multi-step process which requires specialized machinery for each stage of the production process. Generally, the printed material is supplied in a roll.

The initial stage may be followed by a second stage where a second machine may be used to adhere material (e.g. a laminated printed material) to the surface of a base item, for example, to the surface of a double-sided adhesive tape. Prior to the second stage, in an optional intermediate is stage, a machine may be used to emboss or embed the printing on the printed material. In a third stage, a machine may be used to form perforations in the printed material while adhered to the base item, outlining a shape of the final item. In a fourth stage, cutting may be performed along the perforations, either manually or using a machine, to produce the printed item.

It is believed that the following publications represent the relevant technology in the field: U.S. Pat. No. 4,093,277 (Nolan et al., 1978 Jun. 6); U.S. Pat. No. 4,824,503 (Wilen, 1989 Apr. 25); U.S. Pat. No. 5,645,932 (Uchibori, 1997 Jul. 8); U.S. Pat. No. 5,763,128 (Malhotra, 1998 Jun. 9); U.S. Pat. No. 6,171,683 (Trask, 2001 Jan. 9); U.S. Pat. No. 7,824,029 (Jones et al., 2010 Nov. 2); US 2003/167,944 (McKillip, 2003 Sep. 11); US 2004/221,947 (Haldner, et al., 2004 Nov. 11); US 2005/109850 (Jones, 2005 May 26); US 2006/234,014 (Liu et al., 2006 Oct. 19); US 2006/191,426 (Timmerman et al., 2006 Aug. 31); US 2007/012,775 (Cote, 2007 Jan. 18); US 2007/175,573 (Fox et al., 2007 Aug. 2); US 2008/248,261 (Bonnett et al., 2008 Oct. 9): US 2012/132,339 (Foley et al., 2012 May 31); US 2012/211,154 (Brownell, 2012 Aug. 23); and US 2014/290,834 (Egron et al., 2014 Oct. 2).

### SUMMARY OF THE INVENTION

The present invention relates to a system and a method for producing roll printed items. The printing system and method utilize a feeding unit designed for feeding individual/single sheets, one at a time, rather than requiring a feeding roll of printed material. The individual (single) sheets are adhered to a continuous sheet, thereby turning each one of the single and separate printed sheets into a continuous printed sheet (roll). This allows utilizing a separated sheet printer for producing the continuous printed sheet.

In accordance with one aspect of the present invention there is provided a system as defined in claim 1 and the claim(s) dependent therefrom.

In accordance with another aspect of the present invention there is provided a method as defined in claim 18 and the claim(s) dependent therefrom.

In an attempt to allow smaller printing companies to produce smaller amounts of printed product at relatively feasible production costs, self-adhesive paper is typically used. The small printing company may then perform the printing on the rolls, including embossing/embedding, as may be required: and may perform the perforating and/or cutting, as may be required. Such rolls are relatively costly, and the rolls come in predetermined lengths which are not always fully utilized by the small printing company, further increasing the cost of the material.

Production costs may be reduced, particularly for the small printing company, by reducing, if not eliminating, the need to purchase sheet material in ready-form rolls, and by allowing use of flat printed sheet materials thereby reducing material waste as may be typically encountered when using the ready-form labels. Further, easily operated existing and less expensive printing machines can be used, whereby less labor is required.

Printing machines that take a blank label roll, and print on that roll to make labels are very expensive. In contrast, the present system and method provides a “sheet-to-roll” production, in contrast to the common “roll-to-roll” or “roll-to-sheet systems/methods.

It is important to note that, the present system and method not only allows for arrangement of printing on the separate/individual sheets, they also allow for arrangement between those sheets so the printing is arranged equidistantly throughout the entire roll that is produced. In other words, the equidistant spacing between the printed items (e.g. labels) is not just spaced equidistantly on the same page/sheet, rather also all along the roll. Specifically, the distance between a printed item located at the edge of one sheet is spaced apart from the closest printed item on an adjacent sheet as it is to the printed item next to it on the same sheet. Thus, all the printed items are spaced apart the same on the entire resultant roll. This sheet-to-sheet arrangement of printed items can be very precise, which is very important in the printing industry, for example when printing labels, in particular for the cutting process and other post-printing processes.

Further, another possible advantage of the present system and method is that the overlapping sheets mitigate the chance of adhesive/glue seepage. This can be a serious issue as such seepage can shut down the entire printing system, require labor-intensive work to get the system online, and cause serious and costly delays.

In addition, the present system and method take advantage of (previously) printed individual sheets, with printed material (e.g. from an under-employed sheet printing machine) and makes the individual (single)/separate sheets into a roll of labels. Printing machines these days are under-employed for a variety of reasons, including electronic screens are used instead of paper (e.g. restaurant menus are often provided in via a computer tablet rather than a printed menu; brochures, etc. also); and digital advertising rather than paper/material fliers. The system and method take advantage of this by using the existing regular printing machines to make the single printed sheets (i.e. not those that use a roll as in typically label making machines) and can increase the printing opportunities and profitability.

The present system can take virtually any size and weight paper, not just the standard (limited) size/weight as in the typically expensive continuous roll machines, and can thus increase the variety of possible printed products.

### BRIEF DESCRIPTION OF THE DRAWINGS

The invention may be more clearly understood upon reading of the following detailed description of non-limiting exemplary embodiments thereof, with reference to the following drawings, in which:

FIG. 1 is a schematic perspective view of a front side of an exemplary automatic sheet processing system, according to embodiments of the present invention.

FIG. 2 is a schematic side view of FIG. 1.

FIG. 3 is another front side (from the distal end) perspective view of FIG. 1.

FIG. 4 is another (rear) perspective view of FIG. 1.

FIG. 5 is a side view of the automatic sheet processing system, including an exemplary laminating film tension device, according to embodiments of the present invention.

FIG. 6 is a side view of the automatic sheet processing system, including additional exemplary laminating film tension devices, according to embodiments of the present invention.

FIGS. 7A and 7B are top views respectively illustrating a single printed sheet, after being cut to size; and a pair of printed sheets with equidistant spacing of printed items (labels) on overlapping individual sheets.

FIG. 8 is an exemplary sheet for use the present sheet processing system, wherein the margins (only) of the sheet are laminated.

FIG. 9 is a perspective view of the automatic sheet processing system, in accordance with embodiments.

The following detailed description of embodiments of the invention refers to the accompanying drawings referred to above. Dimensions of components and features shown in the figures are chosen for convenience or clarity of presentation and are not necessarily shown to scale. Wherever possible, the same reference numbers will be used throughout the drawings and the following description to refer to the same and like parts.

### DETAILED DESCRIPTION OF EMBODIMENTS

Illustrative embodiments of the invention are described below. In the interest of clarity, not all features/components of an actual implementation are necessarily described.

One improvement provided by the present system and method is to feed or otherwise arrange the singular fed sheets so as to slightly overlap (i.e. the front edge of the subsequent sheet is disposed slightly on top of the rear edge of the previous sheet—or vice versa). In some embodiments, such overlapping may be in the range of 0.1-150 mm.

Such an arrangement of sheets helps prevent a situation that occurs with touching “kissing” (rear edge to subsequent front edge of adjacent sheets), wherein adhesive/glue can seep between the sheets and compromise the process; e.g. dirt the printing machine. Moreover, the glue applicator cylinder/roll drum should thereby stay uniform in order to provide the proper glue application and prevent “jumping” due to a non-uniform layer of glue on the roll.

In an alternate and/or additional feature or aspect, instead of gluing and then adding a (e.g. silicone) cover sheet, the individual/single sheets can be produced with double-sided adhesive, thereby eliminating the gluing and “silicone” (cover layer) step.

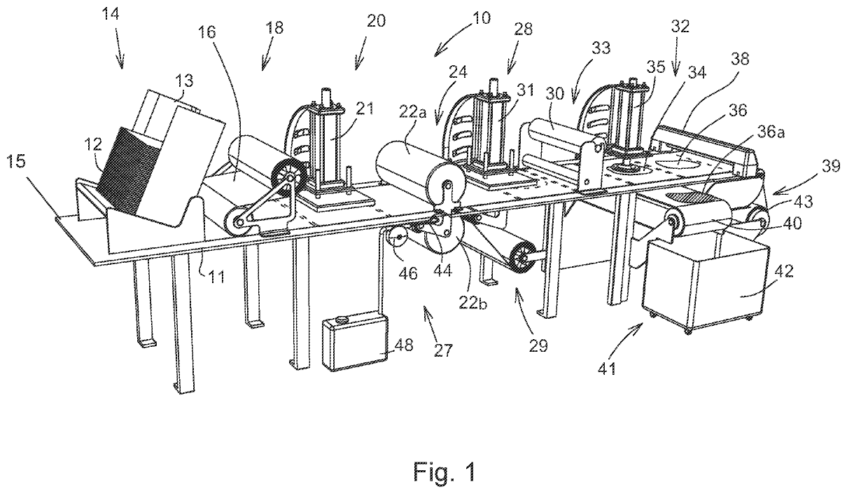

FIGS. 1-5 schematically illustrate an exemplary automatic sheet processing system 10 of the present invention. System 10 may include a sheet feeding station 14, a laminating station 18, an optional embossing/embedding station 20, a base item application station 24, a shape-cutting station 28, an optional non-perforated laminated sheet collection station 33, an optional stripping unit or item cutting station 32, a transport roller station 39 (aka rewinder), and a platform 11 on which the stations are positioned sequentially in a substantially straight line. Additionally, system 10 may include an item collection station 41. There may be voltage control throughout the length of automatic sheet processing system 10.

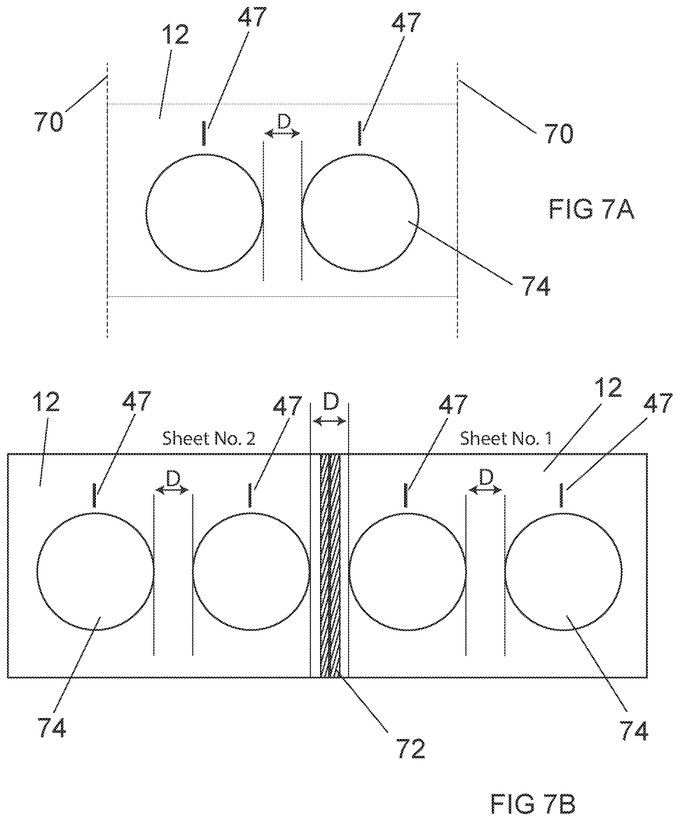

To ensure that the stamping/cutting is accurate after the printed sheets 12 enter the connection station (using lamination; double-sided self-adhesive paper; or cellophane tape), there may be a monitoring and distance-adjustment unit 37 that follows an eye mark 47 that recalculates the distances between printed items 74 (FIGS. 7A, 7B; e.g. labels) at each sheet entry. If there is a deviation, the cutting control/distance monitoring system updates control roll 39 in real time. The distance-adjustment unit 37 may include a sensor (e.g. an optic camera, not shown) that reads the distance between printed items 74 (i.e. eye marks 47); or use a vision technology system, which is typically more accurate.

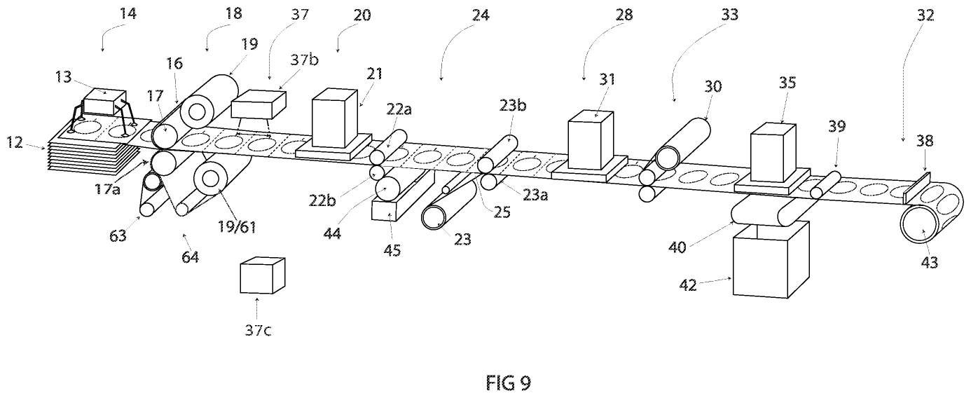

Sheet feeding station 14 may be the first station and include an automatic feeder 13 to accommodate printed sheets 12. Printed sheets 12 may include paper sheets or other flat paper-based products (e.g. polyester, vinyl, self-adhesive paper, etc.) having printed matter such as shapes, figures, letters, and/or numbers. Printed sheets 12 may be subject to lamination and adhered to a base item to form adherable stickers such as magnetic stickers, labels, paper stickers, as well as other types of flat printed items 74, which may be laminated. The lamination can be applied to the upper and/or lower sides of the sheet 12, as illustrated in FIG. 9.

Laminating station 18 may be the next station and may include a laminating material roll 19 and a pressing roller 17. Laminating material roll 19 provides a laminating film 16 which may include a transparent or translucent plastic film or other type of polymer cover, which may be adhered to an upper side of printed sheets 12 by pressing roller 17 as the printed sheet is fed between the pressing roller and a platform or surface top 15 of platform 11.

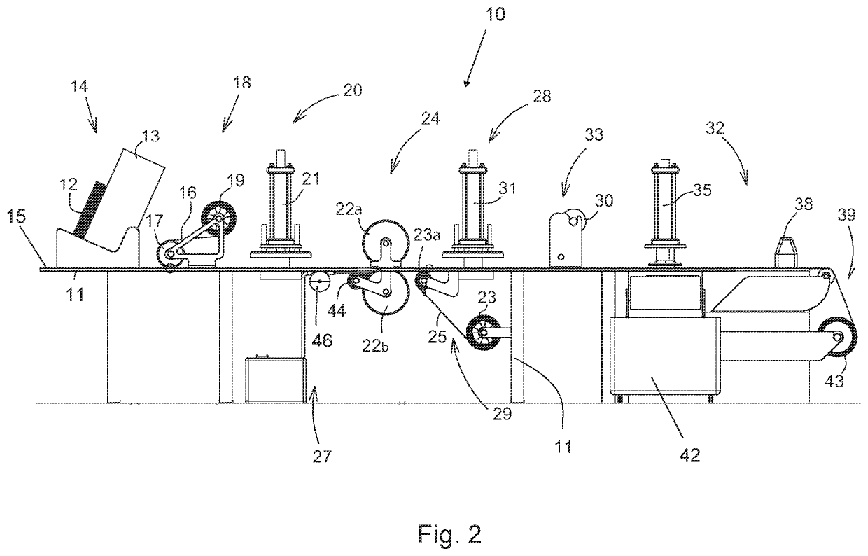

FIG. 2 shows details of printed sheets 12 with laminating film 16 thermally adhered to its upper side by pressing roller 17. Printed sheets 12 are fed by sheet feeding station 14 so as to overlap at their front and rear edges (as illustrated in FIG. 7B).

Embedding/embossing station 20 may include an embedding/embossing press machine 21, which may be used to embed or emboss printed matter on printed sheets 12. Embedding/embossing station 20 may be an optional intermediate station, following laminating station 18, and may be either temporarily installed in the system as required for embedding/embossing printed processes, or may be permanently mounted on platform 11 and only used when required.

Base item application station 24 may be the next station in the system 10, following laminating station 18, and optionally following embedding/embossing station 20. Base item application station 24 may adhere an underside of printed sheet 12 to an upper side of a base item 25, which may include a silicone material (e.g. silicone paper), a rubber, or other polymeric material, and may serve as a base for an underside of the flat laminated printed item. Base item 25 may include a magnetic material. Additionally or alternatively, base material may include an applied adhesive on an underside of base item 25 covered with a removable adhesive-resistant material (e.g. silicone) paper or carton. It is possible to coat the paper or silicone/carton/magnet.

Base item application station 24 may include an adhesive applying subsystem 27 and a base item supply subsystem 29. Adhesive applying subsystem 27 may include a glue container 45, a glue pump 46, a glue applicator 44, a top guide roller 22a and a bottom guide roller 22b. Glue container 45 may be any type of container suitable for storing glue, which may be used for adhering printed sheet 12 to base item 25. Glue pump 46 may apply glue by means of glue applicator 44 to bottom guide roller 22b, which may in turn apply the glue to the underside of printed sheet 12 as it passes between top guide roller 22a and bottom guide roller 22b. Top guide roller 22a guides printed sheet 12 between the two rollers as the glue is applied to the underside. Base item supply subsystem 29 may include a base item roll 23 and a feed roller 23a (FIG. 2). Base item supply roll 23 may be positioned on an underside of platform 11 and may supply base item 25 which is fed to surface top 15 by feed roller 23a, where it is adhered to the glue-coated underside of printed sheet 12. FIG. 2 illustrates printed sheet 12 with laminating film 16 adhered to its upper side and with base item 25 adhered to its underside.

There may be a glue application quality control system (not shown) that checks the state of glue application on the paper/silicone to ensure that the glue application is proper and uniform. Glue applicator 44 may have associated therewith an intercooler unit (not shown) configured to cool the hot glue.

Shape-cutting station 28 may be the next station in system 10 following base item application station 24. Shape-cutting station 28 may include a perforating machine 31 for creating perforations on printed sheet 12 while adhered to base item 25. The perforations may be according to a predetermined pattern, and may be associated with a shape of the final printed laminated item 36a (FIG. 1). The perforations may be made only on printed sheet 12 and not on base item 25, or alternatively, may be made in both the laminated printed sheet and the base item. The perforations may be partial perforations to allow easy removal of the perforated shapes later on, either by machine, or manually by an operator or a final user of laminated item 36a. Alternatively, the perforations may be complete perforations separating the perforated shape on printed sheet 12 which form laminated item 36a from non-perforated sections on the sheet. Shape-cutting station 28 may be an optional intermediate station in system 10 following base item application station 24, and may be either temporarily installed in the system when required, or may be permanently mounted on platform 11 and only used when required. The cutting may be via a LASER.

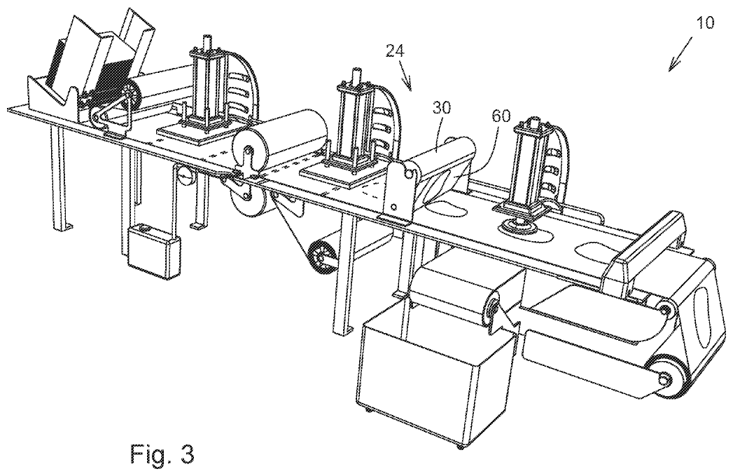

Processed sheet collection station 33 may include a collection roller 30 which may be used to separate sections of processed printed sheet 12 from base item 25 that do not form part of final processed item 36a; and to collect the separated sections 60 on the roller (FIG. 3). Processed sheet collection station 33 may be an optional intermediate station in system 10 following Shape-cutting station 28, and may be either temporarily installed in the system when required, or may be permanently mounted on platform 11 and only used when required.

Stripping unit or item cutting station 32 may include a stripping station 35 and/or a cutting machine 38, which may be used in place of perforation station 24 or alternatively, may supplement the perforation station. Stripping station 35 may be used to cut out a predetermined shape of final laminated/processed item 36a from printed sheet 12 adhered to base item 25 (i.e. the shape is separated from the printed sheet adhered to the base item). Cutting machine 38 may be used to cut shapes of predetermined dimensions from printed sheet 12 adhered to base item 25. Item cutting station 32 may be an optional intermediate station in system 10 following sheet collection station 33, and stripping station 35 and/or cutting machine 38 may be either temporarily installed in the system when required, or may be permanently mounted on platform 11 and only used when required.

An item collection station 41 may be the next station following any one of the optional stations 28, 33 and 32, and may serve to collect final printed item 36a in any one of its forms (perforated shapes, punched out shapes, cut out rectangular shapes, or other possible shapes and/or combinations thereof). Item cutting station 32 may be in communication with item collection station 41 by means of an opening through which final printed item 36a may drop onto a conveyor 40 which transports the final printed item to a collection container 42. As illustrated in FIG. 1, the opening through which final printed item 36a drops onto conveyor 40 may be through an opening 36 formed in printed sheet 12 adhered to base item 25. Alternatively to the use of conveyor 40, collection container 42 may be placed directly under opening 36 and onto which may drop the cut or punched out final printed item 36a. Alternatively, final printed item 36a may be manually acquired by an operator while on surface top 15, so that opening 36 may not be required.

Transport roller station 39 may include a collection roller 43 and may provide a transport mechanism for pulling on film 16 to transport printed sheet 12 through the stations of system 10. Printed sheet 12 may also be transported through stations while adhered to base item 25 and may be collected by collection roller 43 following prior collection of final printed item 36a. Alternatively, prior collection of final printed item 36a may not be performed, rather accumulated on collection roller 43 for further processing. Alternatively, transport roller station 39 may pull on base item 25 with attached perforated shapes of final printed item 36a while sections 60 of Printed sheet 12 which do not form part of the final printed item are collected by sheet collection station 33. Following prior collection of final printed item 36a, remaining base item 25 may be collected by collection roller 43. Alternatively, base item 25, including final printed item 36a, may be collected on collection roller 43.

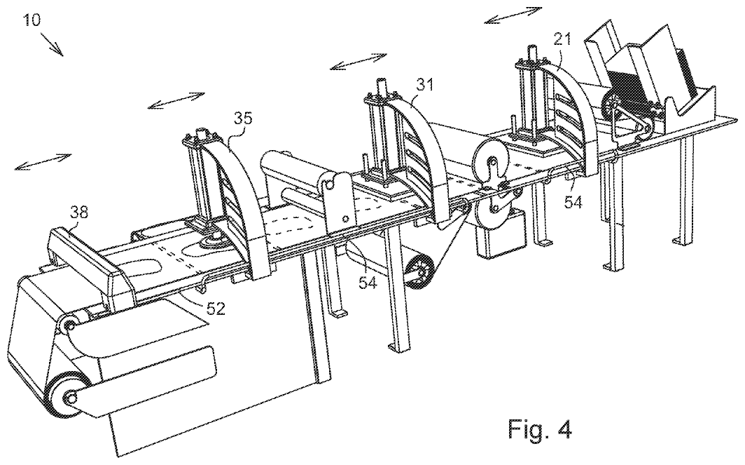

With reference to FIG. 4, platform 15 may include tracks 52 onto which machines 21, 31, 35, and 38 may be removably attached as required, and which may allow moving the machines linearly to any position along the tracks. The possibility to position the machines anywhere along tracks 52 may allow for interchangeability in the sequence of the machines depending on the production requirements of the final printed item 36a, and may further allow for better alignment of the machines during pre-production setup. Movement of machines 21, 31, 35 and 38 along tracks 52 may be facilitated by pneumatic means 54, which may be used to power movement mechanisms in the various machines. Additionally or alternatively, movement may be facilitated by electromechanical means such as motor driven gears or wheels, among other possible electromechanical movement mechanisms.

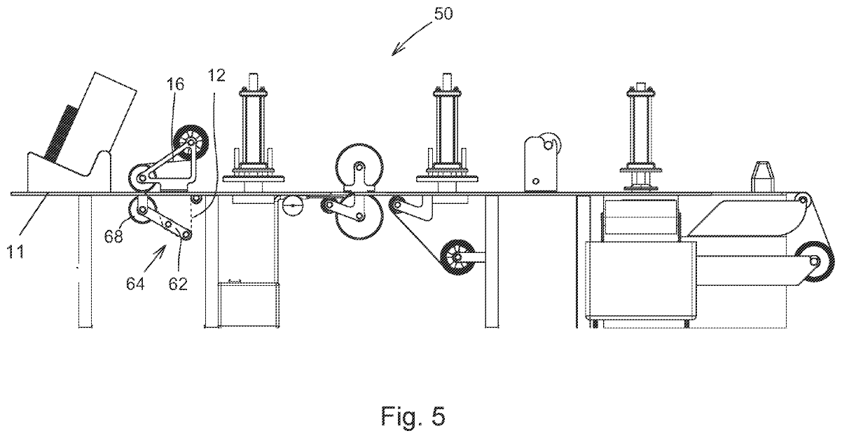

As illustrated in FIG. 5 system 10 but may include a film tension device 64 similar to film tension devices known in the art. Film tension device 64 may include a feed roller 68 and a rotatable lever 62 attached to an underside of platform 11. Film tension device 64 may serve to delay feeding of film 16 and thereby printed sheets 12 through system 10 for very small durations to maintain a predetermined tension on the printed material as it is being processed. System 10 may be fitted with film tension device 64 at various locations throughout platform 11 to control tension at several points along the production process.

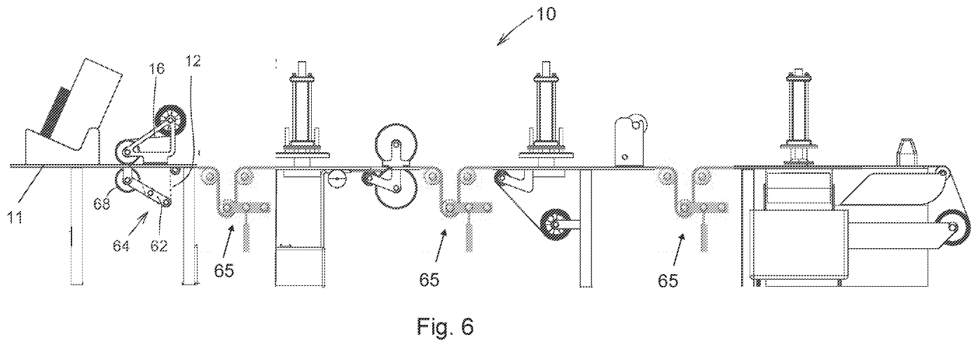

FIG. 6 shows the system of FIG. 5 with additional film tension devices 65, also known as “dancers”. These “dancers” ensure tension at additional stages of the process.

FIG. 7A shows a single printed sheet 12, after being cut to size along dashed lines 70, in a “pre-cutting” step. Sheets 12 are cut so that their front and rear edges will overlap slightly with those of adjacent sheets during processing, as seen in FIG. 7B. FIG. 7B further shows that the pre-cutting and slight overlap 72 is designed such that the distance D between printed material/labels 74 is equidistant all along the sequence of printed items (labels) on the overlapping individual sheets 12. In other words, this distance D is not just the same on each sheet 12, rather also between adjacent labels 74 of adjacent sheets 12 (and thus throughout the entire sequence of overlapping sheets 12. As such, a continuous roll (sequence of sheets 12) is formed from the sequential individual sheets 12 with a continual repetition of equidistant labels 74, as appropriate for the cutting stage.

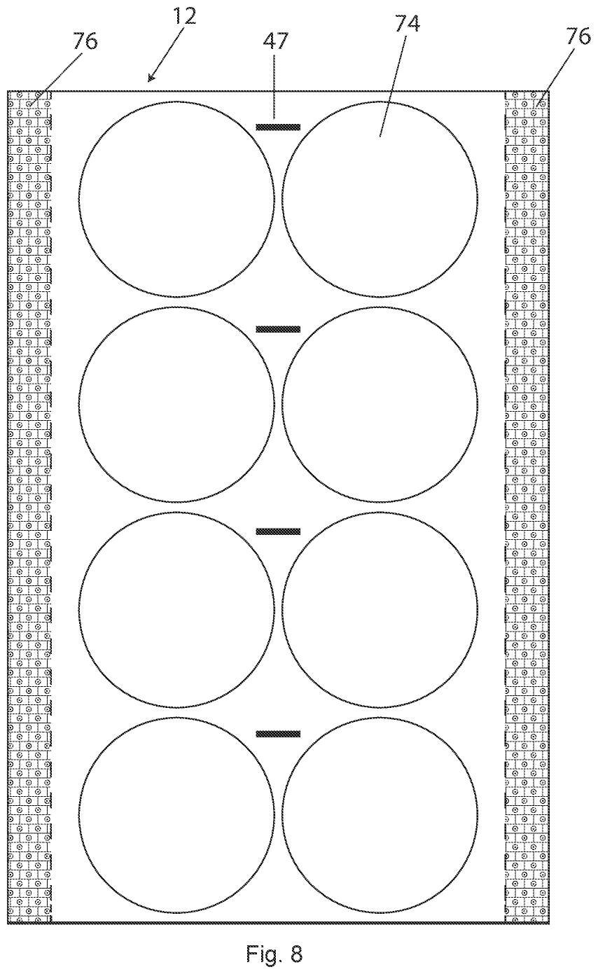

FIG. 8 shows a partially laminated printed sheet 12 wherein only the side margins 76 of the sheet are laminated. Such a sheet allows sheet processing in the case where there is no need for lamination in the area of the labels/items 74, and thus the laminated portion is only required in the margins in order to connect between previous and subsequent sheets 12. Additionally or alternatively, a film can be used instead of the lamination alongside margins 76.

FIG. 9 shows an alternately designed sheet feeding station 14, wherein automatic feeder 13 is a computerized feeder that uses a vacuum to grab the sheets and arrange them in the proper overlap. The design also includes a lower press roller 17a; a roll with double-sided tape 61 (or cello tape); double-sided tape release-paper collector roll 63; glue tank 45; and an upper press roller 23b. The sheet processing system includes monitoring and distance-adjustment unit 37 including a distance measuring element 37b (e.g. optical); and a programmable logic controller 37c, which controls the entire process including controlling and monitoring the distance between eye marks 47, for example via a servo motor to properly adjust the distance between printed items 74, as needed.

It should be understood that the above description is merely exemplary and that there are various embodiments of the present invention that may be devised, mutatis mutandis, and that the features described in the above-described embodiments, and those not described herein, may be used separately or in any suitable combination: and the invention can be devised in accordance with embodiments not necessarily described above.

1. A sheet processing system comprising:
a sheet feeding station, configured to feed and place single and separate printed sheets, one at a time, on at least one continuous sheet, one printed sheet adjacent to the other with a front edge of one printed sheet of the separate printed sheets overlapping on top of or below a rear edge of its previously fed printed sheet; and
a pressing roller configured to move said at least one continuous sheet, and to adhere the at least one continuous sheet on said printed sheets, thereby turning each one of the fed single and separate printed sheets into a continuous printed sheet, thereby allowing utilizing a separated sheet printer for producing said continuous printed sheet.

2. The system according to claim 1, wherein said at least one continuous sheet comprises a laminating material or a double-sided tape or cello tape.

3. The system according to claim 1, wherein said at least one continuous sheet comprises a base item, selected from a group including: an adherable removable sticker sheet; a label sheet; and a magnetic sheet.

4. The system according to claim 1, wherein said sheet feeding station is configured to feed said printed sheets to a laminating station; wherein said laminating station is configured to adhere said continuous sheet to said printed sheets to produce a laminated printed sheet; wherein said pressing roller comprises a base item application station configured to apply said at least one continuous sheet comprising a base item to said printed sheets; and wherein said sheets processing system further comprises: a platform configured to accommodate said sheet feeding station, said laminating station, said base item application station, and a transport roller station, aligned in a substantially straight line; and a transport roller station configured to transport said printed sheets along said platform.

5. The system according to claim 4, wherein said printed sheets are of a paper-based material.

6. The system according to claim 4, wherein said sheet feeding station comprises an automatic sheet feeder.

7. The system according to claim 4, wherein said laminating station comprises a pressing roller configured to thermally adhere said laminating material to said printed sheets.

8. The system according to claim 4, wherein said laminating station comprises a laminating tension device configured to apply tension to said laminated printed sheets being laminated.

9. The system according to claim 4, wherein said base item comprises any one of a rubber material, a silicone material, a polymer-based material, a magnetic material, a paper-based material, and a fabric.

10. The system according to claim 4, wherein said base item application station comprises an adhesive applying substation configured to apply an adhesive to an underside of said laminated printed sheets.

11. The system according to claim 10, further comprising an adhesive applying substation, which comprises: a top guide roller; a bottom guide roller; a glue container, a glue pump; and a glue applicator.

12. The system according to claim 4, further comprising an embedding/embossing station configured to embed or emboss the print on said laminated printed sheets, wherein said embedding/embossing station is aligned with said laminating station on said platform.

13. The system according to claim 4, further comprising a perforation station to perforate a predetermined shape of the laminated printed item on said laminated printed sheets, wherein said perforation station is aligned with said laminating station on said platform.

14. The system according to claim 4, further comprising an item cutting station configured to cut a predetermined shape of the laminated printed item on said laminated printed sheets and said applied base item, wherein said cutting station is aligned with said laminating station on said platform.

15. The system according to claim 16, wherein said item cutting station comprises a stripping station configured to punch out said predetermined shape from said laminated printed sheets and said applied base item.

16. The system according to claim 4, further comprising a laminated sheet collection station to separate and collect sections of said laminated printed sheets that do not form part of the laminated printed item, wherein said laminated sheet collection station is aligned with said laminating station on said platform.

17. The system according to claim 1, further comprising a monitoring and distance-adjustment unit including a control roll; a distance measuring element; and a programmable logic controller, which controls the distance between eye marks to properly adjust the distance between printed items, as needed.

18. A method of producing a processed printed item, the method comprising:
feeding single and separate pre-cut printed sheets, one at a time, on at least one continuous sheet, one printed sheet adjacent to the other with a front edge of one printed sheet of the separate printed sheets overlapping on top of or below a rear edge of its previously fed printed sheet; and
adhering the at least one continuous sheet to said printed sheets, thereby turning each one of the fed single and separate printed sheets into a continuous roll of printed sheets, thereby allowing utilizing a separated sheet printer for producing said continuous roll of printed sheets.

19. The method of claim 18, wherein the step of feeding the single and separate printed sheets comprises arranging the overlapping of the sheets so that printed material thereon is equidistantly spaced all along said continuous printed sheet.
